(19) United States
(12) Patent Application Publication
(10) Pub. No.: US 2006/0164221 A1
(43) Pub. Date: Jul. 27, 2006

(54) Sensor-activated controlled safety or warning light mounted on or facing toward rear of vehicle

(76) Inventor: John Michael Jensen, Santa Monica, CA (US)

Correspondence Address: John M. Jensen, P.O. Box 165, Santa Monica, CA, 90406, US

(21) Appl. No.: 11/036,812

(22) Filed: Jan. 18, 2005

(51) Int. Cl. B60Q 1/00; B60Q 1/50

(52) U.S. Cl. 340/435; 340/464

(57) ABSTRACT

An invention to reduce the occurrence and severity of rear-end vehicle collisions, where two or more sensors are located on (i) the front of or forward facing of the “lead” vehicle and on (ii) the rear of or rearward facing of the “lead” vehicle so as to provide data and information to a controller that processes the sensor information and generates signals to one or more light emitting mechanisms mounted on or facing rearward of the “lead vehicle” that emit caution light to warn the driver of the “following vehicle” about the speed, distance, presence, approach, or other characteristics of nearby vehicles located behind, in front of, and including the lead vehicle.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISK APPENDIX

None

### REFERENCE TO A MICROFICHE APPENDIX

None

### BRIEF DESCRIPTION

A light emitting mechanism, mounted on or facing toward the rear of a vehicle (“lead vehicle”), that is activated by a controller informed by one or more sensors that measures or determines the presence, speed, approach, distance or other characteristics of one or more nearby vehicles such that controller signals the rear light-emitting mechanism to emit light to warn or to encourage the driver of a following vehicle to pay attention, to apply the brakes, to slow, or to stop. In a preferred embodiment of the invention, two or more sensors are located on (i) the front of or forward facing of the lead vehicle and on (ii) the rear of or rearward facing of the lead vehicle so as to provide data and information to a controller that processes the sensor information and generates signals to one or more light emitting mechanisms mounted on or facing rearward of the lead vehicle that emit caution light to warn the driver of the following vehicle about the speed, distance, presence, approach, or other characteristics of nearby vehicles (located behind, in front of, and including the lead vehicle). The inventions will help to decrease the number and severity of rear-end collisions (also referred to as “accidents”) and reduce the amount of “tail gating” or following too close.

### BACKGROUND OF THE INVENTION

This invention pertains to the field of vehicle safety products or collision avoidance products.

This is a crowded field. There are many inventions regarding light emitting mechanisms mounted on or facing the rear of a vehicle.

However, there are no inventions that are mounted on the “lead” vehicle which are activated by one or more rear mounted or rear facing sensors that measure the presence, speed, approach, distance, or other characteristic of a following vehicle such that the sensor provides information to a controller that signals or provides information to the rear-facing light-emitting mechanism to emit light to warn the driver of the following vehicle of the lead vehicle's presence, its speed, its distance, its closing rate, or other variables that provide information or cause the following driver to pay attention or warn the following driver to apply the brakes, or avoid colliding with the rear of the lead vehicle.

There are no inventions that are mounted on the “lead” vehicle which are activated by one or more sensors that are located on the front of or forward facing of the lead vehicle so as to provide information about the speed, distance, presence, approach, or other characteristics of vehicles in front of the lead vehicle to a controller that process the information and sends data to or signals a light emitting mechanism on the rear or facing the rear of the lead vehicle to provide light signals to drivers of following vehicles.

There are no inventions which combine one or more forward facing sensors and one or more rear facing sensors in order to generate information to a controller which processes the sensor data and then provides information to one or more light-emitting mechanisms that are facing rearward of the lead vehicle such as to emit light signals or warnings to drivers of following cars about the speed, distance, approach, presence or other factors or characteristics relating to nearby vehicles in order to warn or to assist the driver of the following vehicle to avoid rear end collisions.

There are no inventions which combine (i) one or more forward facing sensors, (ii) one or more rear facing sensors, and (ii) additional sensors, including sensors related to the lead vehicles characteristics or activity in order to generate information to a controller which processes the sensor data and then provides information to one or more light-emitting mechanisms that are facing rearward of the lead vehicle such as to emit light signals or warnings to drivers of following cars about the speed, distance, approach, presence, or other factors or characteristics relating to nearby vehicles in order to warn or to assist one or more drivers of following vehicles to avoid rear end collisions.

In particular there are no inventions that utilize one or more separate sensor-activated, controlled, rear-directed light-emitting mechanisms wherein the sensor-informed controller activates one or more warning lights based on sensor-provided, controller-processed information related to the presence, speed, approach, distance, or other characteristic of one or more nearby vehicles (and the lead vehicle) such as to warn the driver of the following vehicle to exercise caution, to pay attention, to slow, to stop, to apply the brakes, or to avoid the collision.

The present invention will provide information in addition to brake lights. Brake lights signal that the lead vehicle is braking and slowing. The caution light in the present invention will most likely signal a warning to the driver of a following vehicle related to one of several things including but not limited to: (1) that there is a vehicle in front of the lead vehicle that is slowing or slowing suddenly; (2) that the lead vehicle is present and close even if it is not braking or showing brake lights; (3) That the following vehicle is approaching too rapidly; (4) that the following vehicle is following too closely (“tailgating”); (5) that there is a vehicle in front of the lead vehicle that suddenly changed position or lanes in front of the lead vehicle. These situations are common causes of rear-end collisions. Allowing the driver of the following vehicle some additional time to react with an earlier warning will allow a driver of a following vehicle a greater opportunity to avoid some of these common rear-end collisions.

The separate warning light disclosed in the present invention that is automatically activated by the sensor informed controller based on information about the speed, presence, position, or other characteristic of other vehicles will allow a following driver to be warned so as to steer out of the way or to apply the brakes to avoid a vehicle collision, specifically a rear-end vehicle collision.

For example, the separate warning light disclosed in the present invention that is automatically activated by the sensor informed controller with sensor information from the forward facing sensors relating to the sudden slowing of a vehicle in front of the lead vehicle will allow a following driver to be warned of a suddenly slowing vehicle even before the driver of the lead vehicle applies its brakes.

For example, the separate warning light disclosed in the present invention that is automatically activated by the sensor informed controller at the following vehicle's approach will allow a following driver to be warned of the presence of a stopped lead vehicle in front of it that is not applying its brakes and that does not have its running lights on.

In addition, the present invention provides information including additional warning and distance information to the following driver to allow the following driver to improve his/her ability to quantify distance, see the approaching lead vehicle, receive information about vehicles in front of the lead vehicle, provide additional reaction time and provide assorted other benefits.

In addition, the present invention provides additional warning and distance information to the following driver to allow him/her to distinguish between brake lights, running light, and the warning lights.

In addition, with respect to the forward facing sensors, the present invention provides additional warning and distance information to the following driver to provide him/her with information about what is in front of the lead vehicle even if the following driver can not visually perceive the circumstances. Impaired visual perception is often a problem where a lower profile vehicle follows a higher profile vehicle such as when the lead vehicle is a Sport Utility Vehicle. In these cases, the driver of following lower profile vehicle can not see through the windows of the SUV and has difficulty visually determining the behavior of the vehicles in front of the lead vehicle. The present invention improves the amount of information that the following driver has by providing an independent sensor informed warning light about events or occurrences in front of the lead vehicle.

The separately-triggered, sensor-activated, automatic warning light will provide a following driver with important additional information that is only provided by the present invention.

It has been estimated that rear end collisions account for about 25% of all collisions. There are 5 common types of rear-end collisions: (1) where the lead vehicle is stationary with its brake lights not engaged; (2) where the lead vehicle is stationary with its brake lights engaged; (3) where the lead vehicle is moving with its brake lights engaged; (4) where the lead vehicle is moving with its brakes lights not engaged; (5) where the lead vehicle slows or stops suddenly and the driver of the following vehicle does not have adequate warning of the events causing the lead vehicle to slow or stop suddenly.

Brake lights are fairly effective at preventing rear-end collisions. It is estimated that without brake lights, there would be a dramatic increase in the number and severity of rear end collisions.

However, currently there are still too many rear end collisions. Some rear end collisions are terribly severe where, in addition to property loss on the vehicles, there is substantial injury to people and sometimes death.

Rear end vehicle accidents or collisions usually occur when the following vehicle fails to stop in time, often because the driver of the following vehicle is not paying sufficient attention or does not have sufficient information to avoid the collision. Inventions that help driver of following vehicles to receive more information in order to maneuver or stop the following vehicle in time will reduce the number and severity of rear end collisions or accidents.

The present invention will help to decrease the number of rear end accidents and reduce the amount of “tail gating” or following too close.

Usually rear end collisions are a result of the driver of the following vehicle failing to slow or stop in time because, the following driver does not have sufficient information or his/her attention is not focused adequately. This is often a result of a driver of the following vehicle (i) failing to judge the distance between the vehicles accurately, (ii) failing to perceive the lead vehicle accurately, (iii) failing to see the warning lights or brake lights in sufficient time to react to slow or to stop the following vehicle, (iv) driver inattention or distraction, (v) following driver traveling too quickly, (vi) following driver following too closely, (vii) limitations in the following driver's perceptions, (viii) following driver's inability to see through the lead vehicle or determine the circumstances in front of lead vehicle, (ix) limitations in the following driver's reaction, (x) sudden lane changes in front of the lead vehicle; or (xi) similar or related situations. Rear-end collisions are seldom the fault of the lead vehicle's driver.

Many rear end collisions occur because of the following vehicle is following too closely at a speed such that the following driver does not have sufficient time to react to avoid a collision. Often the following driver does not even know that he is following too close. This invention will provide a warning to the following driver of situations where the following driver is following too close, whether or no the brake lights are engaged.

Many rear end collisions occur because the driver of the following vehicle is approaching too quickly. This invention will provide a warning light to the following driver of situations where the driver of the following car is approaching too quickly, whether or not the brake lights are engaged.

### BRIEF SUMMARY OF THE INVENTION

The present invention provides warnings in the form of light emitted from separate lights on rear of a preceding or leading vehicle (“lead vehicle”) to inform drivers of following vehicles to pay attention to the presence or characteristics of preceding or leading vehicles before them in the roadway to allow drivers in the following vehicles to react to avoid, to prevent and to lessen the occurrence and severity of rear-end vehicle collisions.

A standard vehicle is equipped with brake lights on each side of the rear of the vehicle and a center higher mounted brake light. Inventions related to these standard configurations are common. Vehicles are also typically equipped with running lights in the rear to indicate the vehicle's presence. These running lights historically were used when the front head lights were engaged, but now are typically activated when the vehicle is turned on.

The present invention adds a separate warning light that is in addition to these lights. Although in some embodiments this light can be housed in the same enclosure with either or both the running lights or the brake lights, the warning light in the preferred embodiment should be a separate light emitting mechanism solely engaged with reference to the sensor's or the controller's input/output and should be in addition to and independent of the brake lights and the running lights. As such, in the preferred embodiment, it would be possible for a vehicle to have three sets of lights engaged: (1) the running lights; (2) the brake lights; and (3) the warning light as disclosed in the present invention.

In a preferred embodiment of the present invention, the separate warning light is activated by one or more rear facing or rear mounted sensors that measures data related to a following vehicle including but not limited to the speed, distance, approach, or presence of a following vehicle. As such, this additional warning light will shine in addition to brake lights or running lights to provide additional warning to the driver of an approaching following vehicle that there is a vehicle traveling, stopped, or positioned in front of or near the following vehicle.

In a preferred embodiment of the present invention, the separate warning light is activated by one or more forward facing or forward mounted sensors that measures data related to characteristics of vehicles in front of the lead vehicle including but not limited to the speed, distance, approach, or presence of vehicle in front of the lead vehicle. As such, this additional warning light will shine in addition to brake lights or running lights to provide additional warning to the driver of a following vehicle that there is a vehicle in front of the lead vehicle that is traveling slowly, slowing quickly, stopped, or changing position quickly in front of or near the lead vehicle without the driver of the lead vehicle having to apply its brakes and brake lights.

The most preferred embodiment of the present invention will have both forward facing and rear facing sensors. In the most preferred embodiment of the invention, the separate warning light is activated by either one or more rear facing, rear mounted, forward facing, or forward mounted sensors that measures data related to a vehicle in the vicinity or proximity of the lead vehicle including but not limited to the speed, distance, approach, or presence of a nearby vehicle. As such, this additional warning light will shine in addition to brake lights or running lights to provide additional warning to the driver of a following vehicle of the characteristics of other nearby vehicles.

The additional light is important in both cases where the brake light is engaged and where the brake light is not engaged. Standardly, the brake lights are engaged when the driver of the lead vehicle engages the brake. However, it often occurs that the vehicle in the lead position is stopped without its brakes engaged. As such, there is no warning light emitted by the lead vehicle. With the present invention, the rear-facing sensor activated warning light will engage when the following car is detected to be approaching, thereby warning the driver of the following car of the lead vehicle's presence even without the driver of the lead vehicle applying the brakes. This is an important safety enhancement that will prevent many collisions.

In situations where the driver of the lead vehicle is stopped with the brakes engaged, the sensor activated warning light disclosed in this invention will provide additional warning to an approaching driver of the presence of the lead vehicle and/or the closing distance.

In situations where the lead vehicle is moving and the driver of the lead vehicle is not braking, the invention disclosed herein will provide a warning to the driver of a following vehicle that it is approaching too fast or too close without the driver of the lead vehicle having to apply the brakes. This warning will be generated automatically by the controller such that the driver of the lead vehicle does not have to engage or act to put the warning into effect.

In situations where the lead vehicle is moving and the driver of the lead vehicle is braking, the invention disclosed herein will provide an additional warning to the driver of a following vehicle that is approaching too fast or too close.

In situations where the lead vehicle is moving and the driver of the lead vehicle is not braking, the invention disclosed herein will provide a warning to the driver of a following vehicle that there is a vehicle in front of the lead vehicle that is, for example, slowing rapidly, even without the driver of the lead vehicle having to apply the brakes. This warning will be generated automatically by the controller such that the driver of the lead vehicle does not have to engage or act to put the warning into effect.

The automatic generation of the warning light by the present invention, even before the driver of the lead vehicle applies its brakes, will provide the following driver with additional reaction time and thereby allow the following driver more time to avoid a collision.

Similarly, vehicles are typically equipped with night running lights. This invention will provide a light emitting mechanism that is in addition to the night running lights and the brake lights.

Many rear end collisions occur because of the following vehicle is following too closely. This invention will provide a warning to the following driver of situations where the following driver is following too close, whether or not the brake lights are engaged.

Many rear end collisions occur because the driver of the following vehicle is approaching too quickly. This invention will provide a warning light to the following driver of situations where the driver of the following car is approaching too quickly, whether or not the brake lights are engaged.

Many rear end collisions occur because the driver of the following vehicle can not see the circumstances in front of the lead vehicle. This invention will provide a warning light to the following driver of situations in front of the lead vehicle that he/she may not otherwise be able to perceive. For example, collisions due to the sudden slowing of a vehicle in front of the lead vehicle that is imperceptible to the following driver can nonetheless be warned and avoided by the caution light provided by this invention.

### BRIEF DESCRIPTION OF THE SEVERAL VIEWS OF THE DRAWINGS

N/A. No drawings are necessary.

### DETAILED DESCRIPTION OF THE INVENTION

In its most basic embodiment, the present invention is comprised of one or more sensors, one or more light emitting mechanisms, a controller, a power supply, and connections between these components.

The invention avoids rear-end collisions by sending a warning or caution light signal from the rear of a leading vehicle in the direction of the driver of a following vehicle. The exterior light signal, similar to a vehicle brake light, is triggered by data from one or more sensors that are positioned or directed on one or both of the forward facing or rear ward facing ends or directions of the leading vehicle to detect the presence, speed, approach, or other characteristics of vehicles around the lead vehicle.

The invention functions once the vehicle is started. The sensors are automatically engaged and start receiving stimulus and generating data to the controller. The controller immediately begins processing the data received from the sensors. When the vehicle begins traveling on the road, the sensors detect the presence of other vehicles. The rear facing sensors detect the characteristics of vehicles behind the lead vehicle. The forward facing sensors detect the characteristics of vehicles in front of the lead vehicle. Once the characteristics of the nearby vehicles are detected, the sensors send signals to a controller mounted in the lead vehicle, which processes the data, and then when the criteria to generate a signal are met or exceeded, the controller generates and either sends information or signals directly or indirectly to the light emitting mechanism located on the rear of the leading vehicle to emit light. In certain instances, based on programmed parameters and the data received from the sensors, the controller determines not to trigger or to signal the lights based on programmed thresholds designed to not issue a warning in circumstances where a warning is not useful, such as when there is no danger or when a car is going slowly in traffic.

The controller can also accept information from the vehicle, the vehicle computer, or be incorporated into the vehicle's computer. For example, with the addition of supplementary inputs as desired in the preferred embodiment of the invention, the controller can accept inputs or information from the vehicle's computer about the speed of the vehicle or other conditions. With the addition of supplementary sensors or data input connections, the controller can sense the speed of the vehicle either from such mechanism as the speedometer, from independently sensing the characteristics of the lead vehicle, or in other ways. If incorporated in the vehicle's computer, and many if not most vehicle now have an “on-board computer”, the present invention can be incorporated into the vehicle's safety system, accept more information, and provide more accurate or useful warnings.

Whether existing independently or incorporated into other devices or used with or in other mechanisms, when the controller determines the sensor data dictates that a warning light signal should be sent, the controller directs or triggers the light emitting mechanism to emit warning light signals automatically without requiring input from the driver of the lead vehicle. The light emitting mechanism emits light rearward or in the direction of the rear of the leading vehicle to alert the driver of the following vehicle. The light emitted warning signal is separate from and is generated independently of the leading driver's engagement of the brakes or the running lights. The driver of the following vehicle views the light signal and reacts by, for example, steering out of the way or by braking. As such, by providing the driver of the following vehicle with more reaction time and more information, the light signal on the rear of the leading vehicle will help the following driver avoid a rear-end collision wherein the following vehicle impacts the rear of the lead vehicle.

The intensity, duration, interval, and other characteristics of the warning light in the rear mounted or rear-facing light-emitting mechanism will be controlled by a controller that accepts the data or information from the forward and rear-mounted or facing sensor(s). For example, the controller can be programmed to increase the intensity of the rear-mounted or rear-facing light emitting mechanism in order to provide an adequate warning or provide more information to the following driver.

For example, if the rear-facing sensor detects that the following car is approaching too rapidly, the controller can direct the light emitting mechanism to emit more light or more intense light as the vehicle approaches in order to signal to the following driver to apply the brakes. On the other hand, the controller can direct the light-emitting mechanism to emit more light when the vehicle is farther away so as to provide the more distant vehicle more clear information from a distance.

For example, if the sensor detects that the following car is “tailgating” the lead vehicle, or following too closely, the controller can direct the light-emitting mechanism to emit a less intense light as the following vehicle slows down or increases the distance between the vehicles to a safe interval or distance. On the other hand, the controller can direct the light-emitting mechanism to emit more light as the sensor indicates that the following vehicle is still approaching or increasing its speed.

The amount of or the intensity of the light emitted is important to adequately warn the following driver. The brighter the intensity or the greater the amount of light, the greater the warning or the more likely that the following driver will perceive the warning light. The invention can make use of one or more lights positioned in one or more places on the rear or facing rearward of the lead vehicle. The invention can make use of controller that allows a variable amount or variable intensity of light to be emitted based on the information provided by the sensor (or based on the controller-input preferences of the driver of the lead vehicle).

In the preferred embodiment, the light emitting mechanism will make use of light emitting diodes, LEDS, or halogen lights. In the preferred embodiment of the present invention, the lights will be white lights or clear lights housed in a clear or red translucent or semi-transparent housing or enclosure such as to allow an adequate amount of warning or caution light to be emitted.

With the use of one or more additional sensors, the controller could take into account and adjust the intensity of the light for environmental factors as well, such as night, or rain.

With one or more additional sensors mounted on the front of the lead vehicle, the present invention could also receive information about whether the vehicle is on a congested or traffic-filled street such that the distances and warnings should be adjusted accordingly. For example, the invention may be programmed by the user to allow for closer distances and fewer warnings only at closer distances when the vehicle is moving at slower speeds and there is a vehicle at a close proximity in front. Generally, the warning light would be appropriate in situations such as, for example: (1) the following car is fast approaching and not slowing; (2) a vehicle in front of the lead vehicle suddenly slows; (3) the lead vehicle is stopped in the road without its brake or running lights engaged and the following car is approaching. However, for example, the invention could be programmed to give higher intensity signals if there is a fast moving following vehicle is detected when there is also vehicle detected in front of the lead vehicle that is moving slowly. Obviously a wide variety of circumstances and scenarios could be programmed into the controller under a variety of events, such as to attempt to provide accurate and valuable warnings to the driver of the following vehicle so as to avoid collisions.

For purposes of this discussion, the amount of light or the number of lights used could also be increased or decreased or utilized in lieu of or in addition to the intensity of the light.

By the use of one or more additional sensors or input, the controller could receive more information and adjust the intensity of the light to take into account and adjust the intensity of the light for factors such as the speed of one or more vehicles, the likely size of the lead or following vehicles, the stopping distance of the lead vehicle, the size of the vehicle in front of the lead vehicle, the weather conditions, the distance of the following vehicle, the distance of the vehicle in front of the lead vehicle, the speed of the following vehicle, the speed of the vehicle in front of the lead vehicle, the difference in speed or distance between the lead and following vehicle, the difference in speed or distance between the lead and vehicle in front of the lead vehicle, or combinations of these and other data, input or information.

The exact type of sensor is not important. If more than two rear-facing or two forward-facing sensors are used, it will be preferable to use a combination of sensors of either different types or different placements on the lead vehicle. In the preferred embodiment of the present invention, the sensor or the combination of sensors should determine both speed and position of the following vehicle. In the less preferred embodiments, the sensor only needs to detect the presence of a vehicle within its range to serve the purposes of the present invention. As such, many different types of sensors are available for use. However in the preferred embodiments of the present invention, the sensors should preferably detect the speed, position and other characteristics of the nearby vehicles.

While the entire sensing and switching system is commonly referred to as a sensor, the sensor itself is a system that is made up of several components, including a detector, electronic control unit, relay and power supply.

There are many different types of sensors available for detecting information in this type of situations. The sensor must be sufficiently rugged to be placed in a vehicle. Types of sensors include Doppler effect speed sensors, radar sensors, laser sensors, inductive proximity sensor, capacitive proximity sensor, optical sensors, microwave sensors, light beam sensors, infrared light sensor, ultrasonic sensors, electronic sensors, imaging sensors, scanning sensors, light sensors, thermal scanners, optical scanners, cameras, mechanical sensors, proximity sensors, capacitive, eddy inductive, photoelectric, Hall effect, position sensors, and other types of sensors are well known. Many of these have proved useful in similar embodiments. The present invention is not dependent on the type of sensor, but will make use of any sensor that can practically provide the information needed, including the change in position per time interval. In a preferred embodiment, the present invention will use a sensor or transducer with a variable rate and with a range or span that can reliably detect speed, presence, distance, information or data at distances between 1 foot and 20-300 feet with a low error rate and with appropriate resolution. Typically used would be sensors that measure a wave of a given frequency reflecting from a moving object, and the frequency shifts that occurs. It is well known that if the object is moving toward the transmitter/receiver, the frequency increases, and the amount of frequency shift is directly proportional to the approach speed. A receding reflective surface shifts the frequency downward.

In the preferred embodiment of the present invention, there are 2 or more types or placements of sensor. In the preferred embodiment of the present invention, one or more of the sensor will make use of Doppler Effect speed sensor, similar electromagnetic wave speed sensors, optical, radar, infrared, ultrasonic, or other sensors.

Although there are well-known problems associated with operating sensors in moving or vibrating situations, the present invention requires the use of a sensor positioned on part of the lead vehicle. While the actual position of the sensor(s) on the lead vehicle is not critical, it is expected that the more stable the positioning of the sensor platform, the more reliable and useful the data from the sensor. As such, the sensor may be placed closer to the center of the vehicle. For the rear facing sensor(s), the preferred position is at or near the center brake light, rather than at or near the rear bumper or at or in one of the rear brake lights. For the forward facing sensor(s), the preferred position is at or near the center rear view mirror, rather than at or near the rear bumper or at or in one of the head lights. In any event, vibrations, motions, and other aspects associated with placing the sensor on a moving vehicle are matters that will affect the sensor and the reliability of the data.

The type of controller is not essential. There are many types of controllers known in the art. In the present invention, the controller will need to take in data from the sensors, perform calculations on that data, and then provide information or signals that trigger a light emitting mechanism or provide signals or information to a variable switch which activates the light-emitting mechanism. Basically, the controller must accept data from the sensor, quickly process that data, and then provide a signal or information to the light emitting mechanism to emit light. In the preferred embodiment of the present invention, the controller can accept user defined preferences, input or data. In the most preferred embodiment of the present invention, the controller can accept data from the sensor or sensors, accept data from other sources or sensors, perform calculations on that data, especially with reference to any user defined preferences or input, and then provide a quick signal, information, or output to the light emitting mechanism in such a form as to cause or signal the light emitting mechanism to emit light in the desired amount or with the desired intensity.

Importantly, the preferred embodiment of the controller will allow inputs from the driver of the lead vehicle to input information such as how closely to allow a following driver to remain in traffic, whether to allow signals for tail gating, the size and weight of the lead vehicle, or other information. The Controller will allow the lead driver to input any number of inputs or preferences so as to allow the lead driver to control the type and amount of information that the sensor-activated, rear-facing warning light provides to the following driver. In the most preferred embodiment of the present invention, the controller is integrated in the vehicles computer so as to provide more timely data to generate more reliable useful warning lights

In the preferred embodiment of the present invention, the controller will also accept inputs automatically from other sources for additional information or variables such as the speed of the vehicle. For example, as both the vehicles in front of the lead vehicle and the following vehicles will be traveling in some circumstances, the sensor could detect relative speeds instead of actual speeds. However, actual speed is an important variable in stopping time and stopping distance. As such, in the preferred embodiments of the present invention, the controller will accept data from the vehicle's computer or other inputs or make use of additional sensors in order to accept additional data into its calculations.

Importantly, the sensor-activated rear-facing warning light shall, once programmed or installed, will be able to act automatically to warn the following driver or automatically, in connection with the controller, emit light. The present invention will be able to provide information to the following driver without requiring the lead driver to provide information, react, or otherwise engage or act to engage the present invention.

The type of light used in the light emitting mechanism is not essential. Incandescent, LED, halogens, or other types of light can be used. Generally, these rear facing warning lights are white or clear lights that are housed in a mechanism that has a red-colored mostly translucent or semi-transparent usually plastic fixture or housing so as to produce a red light for the following driver. These lights can be housed in the same housing as the brake light, the running lights, or other lights. However, to maximize the advantage of the invention and to differentiate the warning lights from brake light or running light, it is preferable to house the warning light in an independent housing such that it can separately indicate information to the following driver that is in addition to the information provided by the running lights and the brake lights.

The power source for the sensor, for the controller, the light or the other material, will be generated, supplied, charged from the vehicle itself, its electric system, or another similar power source.

A “lead vehicle” or “leading vehicle” is defined as the vehicle on which the present invention is housed. The “lead vehicle” is the vehicle in front of the “following vehicle”. The lead vehicle is behind the vehicles in front of the “lead vehicle”. Of course, the “following vehicle” could also mount the invention and provide information to vehicles behind it such that the “following vehicle” would be a “lead vehicle” to the vehicles following it. The definitions are intended to be as broad as possible and as inclusive as possible. Light is intended to be broadly construed and considered to be any frequency emitting device. Controller is intended to be broadly construed and defined as any mechanism, computer, device, process, system, or method that takes in information, signals, or data, performs some function, analysis, process, or calculation, and outputs information, signals, or data. Rear is intended to be broadly construed. Forward is intended to be broadly construed. Sensor is intended to be broadly construed to include any device, mechanism, system, reactive material, signal producer, method or step of method that can react, act on, detect or acquire information. All other terms are intended to be construed as broadly as possible.

The preferred embodiment disclosed in the present embodiment is a favored construction or creation of the present invention, but the present invention can be embodied and constructed in many different useful ways and should not be limited by the specific embodiments or specific details listed in this specification.

I claim:

1. To prevent or to reduce the occurrence or severity of rear-end vehicle collisions, one or more sensor-activated controlled warning light(s) mounted on or facing the rear of vehicle to warn drivers of following vehicles of the speed, distance, presence, or other characteristics of one or more nearby vehicles comprising on a lead vehicle:
(a) One or more separate rear-facing or rear-mounted light-emitting mechanisms, including use of incandescent lights and fixtures;
(b) one or more rear-mounted or rear-facing sensors;
(c) a controller;
(d) a connection between the light-emitting mechanism, the sensor(s), the power supply, and the controller;
(e) A power supply.

2. the invention of claim 1 where there is more than one sensor.

3. The invention of claim 1 where there are sensors are placed or facing in a forward direction.

4. The invention of claim 1 where the controller provides for a variable intensity or amount of light.

5. The invention of claim 1 where the light emitting mechanism uses one or more halogen lights and fixtures.

6. The invention of claim 1 where the light emitting mechanism uses one or more Light emitting diodes or LEDs.

7. The invention of claim 1 where the one or more light-emitting mechanisms are combined in a housing with a brake light or a running light.

8. The invention of claim one where one or more sensors is a Doppler Effect speed sensor or similar electromagnetic wave speed sensors.

9. The invention of claim one where one or more sensors is a Doppler radar speed sensor.

10. The invention of claim one where the controller accepts data from one or more sensors, processes that data, and then directly or indirectly outputs or signals the light emitting mechanism to emit light in desired quantities or intensities.

11. The invention of claim one where the controller accepts data from one or more sensors, accepts user inputs or information, processes the sensor data in accord with the information provided by the user and the controller's program parameters, and then outputs or signals the light emitting mechanism to emit light in desired quantities or intensities.

12. The invention of claim one where the controller accepts data from one or more rear-facing sensors, accepts data from one or more front-facing sensors, accepts user inputs or information, process the sensor data in accord with the information provided by the user and controller's program parameters, and then outputs or signals the light emitting mechanism to emit light in desired quantities or intensities.

13. The invention of claim one where the power supply is derived from the lead vehicle or its electrical system.

14. The invention of claim one where the connection is electrical wiring.

15. The invention of claim 1 where one or more sensors are placed or facing in a forward direction and where one or more sensors are placed or facing in a rearward direction.

16. The invention of claim 1 where the controller accepts additional information from the vehicle's computer, is integrated in the vehicle's onboard computer, or accepts additional information from additional sensors or inputs about the characteristics or activities of the vehicle.

17. The invention of claim 1 where the sensors are of different types or placements on the vehicle.

18. The invention of claim one, where there is one or more side mounted sensors or side mounted warning lights.

19. To prevent or to reduce the occurrence or severity of rear-end vehicle collisions, one or more warning lights mounted on or facing the rear of vehicle that are activated by information from one or more sensors which provide information to a controller which triggers the warning lights(s) to warn drivers of following vehicles of the speed, distance, presence, or other characteristics of nearby vehicles comprising on lead vehicle:
(a) one or more separate rear-facing or rear-mounted light-emitting mechanism(s) or devices including LED, incandescent or halogen lights and fixtures;
(b) one or more rear-mounted or rear-facing sensors and one or more forward-mounted or forward facing sensors of Doppler Effect speed sensor type including radar;
(c) a controller, integrated with a vehicle's onboard computer that receives information from the sensors, receives additional information or inputs, and then triggers or controls the rear-facing warning lights based on a programmed paradigm that accepts user inputs;
(d) a connection between the rear-facing or rear-mounted light-emitting mechanisms, the sensors, the power supply, and the controller;
(e) A power supply that is powered by the vehicle's electrical system, generator, or battery.

20. The invention of claim 19, where the warning lights are facing the rear and in addition are also positioned on or facing to the sides of the vehicle.
